(19) United States
(12) Patent Application Publication
(10) Pub. No.: US 2019/0024404 A1
(43) Pub. Date: Jan. 24, 2019

(54) Modular Paneling System

(71) Applicant: Nolan Dobson, Orem, UT (US)

(72) Inventor: Nolan Dobson, Orem, UT (US)

(21) Appl. No.: 15/657,138

(22) Filed: Jul. 22, 2017

(51) Int. Cl. E04H 17/16; B32B 37/12; B32B 27/32; B32B 15/20; E04H 17/20

(52) U.S. Cl. CPC E04H 17/165; B32B 37/12; B32B 27/32; B32B 2607/00; E04H 17/20; E04H 17/168; B32B 15/20

(57) ABSTRACT

A modular panel may be used as part of a wall system. The modular panel comprises a core substrate followed by an inner layer and a stucco outer layer. The panel is configured to be removably attached at sides to other panels to form a wall.

### BACKGROUND

Fences provide a protective barrier and often accent the aesthetic appearance of a house or building. To that end, various materials are used to make a fence, such as concrete, metal, wood, mesh, and stucco.

Unfortunately, there are drawbacks with the materials. For example, concrete and metal are heavy, making fences less portable or not portable at all. Alternatively, a wall may have a wood core layer followed by a mesh layer. The mesh layer is used to hold a base coating and a sand coating. Alternatively, the mesh layer is used to attach to concrete. These types of fences are labor intensive and yet not durable.

Moreover, materials for a fence can be expensive. Less heavy and costly fences that include cheaper materials, such as plastic, may be more portable but generally do not last as long.

Additional problems are readily discerned indicating that a need exists for improvements to existing fences.

### SUMMARY

A modular panel for a wall system comprises a series of layers that are formed into a panel and that can be used to make a wall. The panel includes a core substrate, two structural layers, and a custom exterior texture. The core substrate is in the center with a front structural layer attached to a front surface of the substrate and a back structural layer attached to a back surface of the substrate. A front exterior texture is applied to the front structural layer and a back exterior texture is applied to the back structural layer.

### BRIEF DESCRIPTION OF DRAWINGS

FIG. 1 illustrates a modular wall panel.

FIG. 2 illustrates a wall formation.

FIG. 3 illustrates a cross-section of a modular panel.

FIG. 4 illustrates attachment of modular panels.

FIG. 5 illustrates a wall with an extruded wall panel.

FIG. 6 illustrates a cross-section of a post.

FIG. 7 illustrates a flow chart of a method for making a wall.

### DETAILED DESCRIPTION

The following describes one or more improvements to wall paneling systems.

A modular panel for a wall system comprises a custom exterior texture applied to a substrate. The substrate may include a series of layers that are formed into a panel and that can be used to make a wall. An exemplary panel includes a core substrate, two structural layers, and an exterior texture. The core substrate is in the center with a front structural layer attached to a front surface of the substrate and a back structural layer attached to a back surface of the substrate. Exterior textures are applied to the outer surface of the structural layers, including a front exterior texture applied to the front structural layer and a back exterior texture applied to the back structural layer.

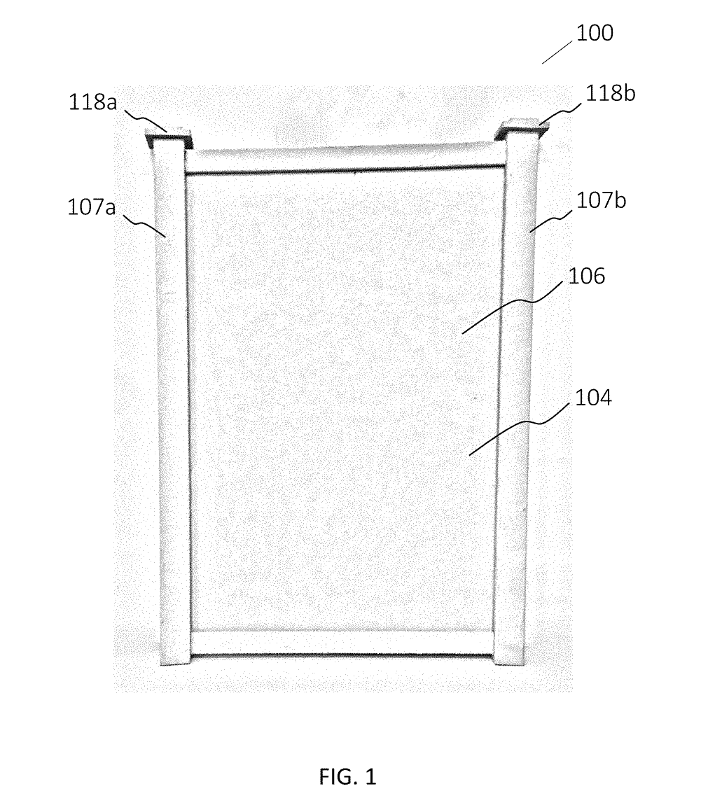

An exemplary wall panel 100 is shown in FIG. 1, including modular panel 102, exterior texture 104, posts 106a and 106b, top border treatment 108, and bottom border treatment 110. Exemplary top headpieces 118a and 118b are shown on top of the posts 106a and 106b.

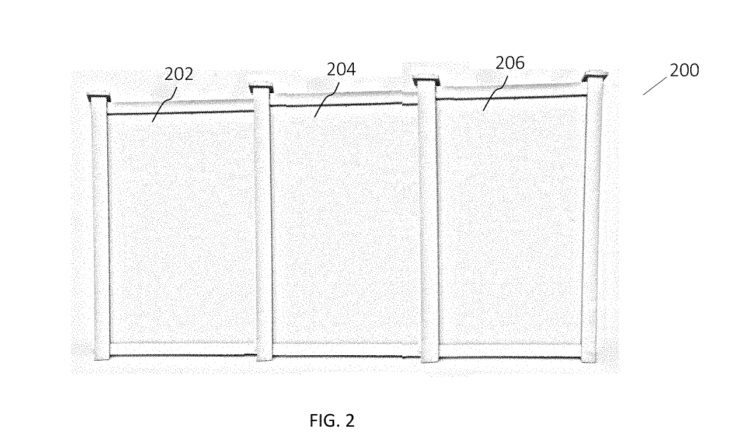

The wall panel 100 includes lightweight materials, and particularly, layers that will be described in more depth below. Wall panels may be connected in a side-by-side arrangement to form a wall, particularly, a fence or border treatment. As shown in FIG. 2, an exemplary wall 200 is formed by wall panels 202, 204, and 206. Each wall panel is connected to another panel at side edges and may use various connective structures known in the art.

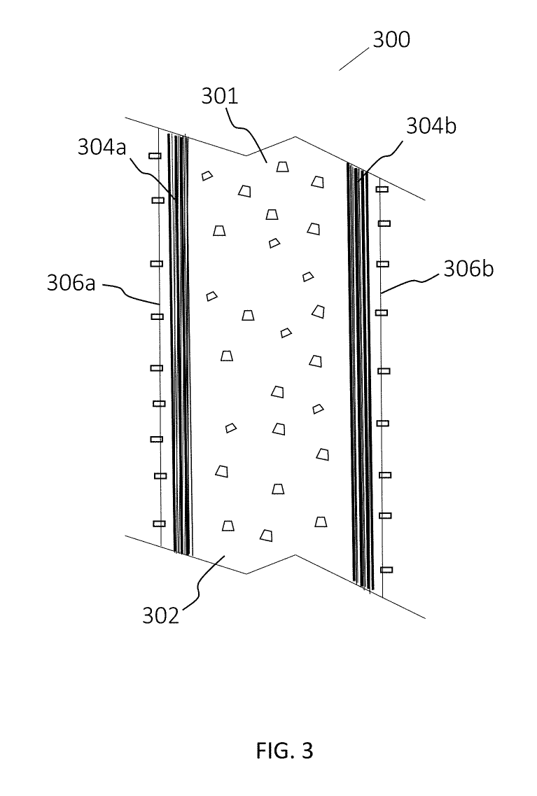

A wall panel includes a substrate that may comprise one or more of a metal and a polymer. The metal and polymer may be a mixture or be made up of layers. Turning to FIG. 3, a substrate 301 is shown made of exemplary layers, including a core layer 302 and structural layers 304a and 304b. An exterior texture 306a and 306b is also shown on the substrate. The core layer may comprise a variety of materials. For example, it may comprise polyethylene or other types of plastic, such as polypropylene. Other exemplary non-limiting forms of polyethylene include one or more of ultra-high-molecular-weight polyethylene (UHMWPE), ultra-low-molecular weight polyethylene (ULMWPE or PE-WAX), high-molecular-weight polyethylene(HMWPE), high-density polyethylene (HDPE), high-density cross-linked polyethylene (HDXLPE), and cross-linked polyethylene (PEX or XLPE). Other types of polyethylene are also contemplated. The substrate material may further include corrugated materials, honeycomb materials, a foam or something that is analogous to foam, such as quantum foam, polyurethane foam (foam rubber), XPS foam, polystyrene, phenolic, or many other manufactured foams. The exterior texture may be in a liquid form, such as a liquid acrylic, a paste or gel form, or other form, when it is applied.

The core provides a generally flat planar surface on both a front and back side. Attached to both front and back sides in a parallel planar manner are respective structural layers 304a and 304b. The composition of the structural layers comprises a stiff material that provides structural support for the panel. An exemplary material for the structural layer comprises aluminum. Other materials include one or more types of metal (e.g. steel, iron, copper, brass, metal composite, etc.) or rigid plastics. The structural layer is thinner than the core, however, embodiments include that the layers be of equal thickness or that the structural layers be thicker than the core.

An exemplary substrate that may be used and that incorporates a core with structural layers is a Dibond® panel. Another exemplary substrate might incorporate a core that is entirely metal or metal composite. To these types of substrates, an exterior texture would be applied to form the modular panel.

As shown, exterior textures 306a and 306b are applied to structural layers 304a and 304b. Exterior textures 306a and 306b are contemplated to provide a customized texture to the outer surfaces, and not merely provide a color or finish. For, example, the exterior texture may provide a rough, uneven, or otherwise jagged outer effect. Unlike a generally linear surface that is thin and that easily cracks, such as paint or other coatings, the texture may simulate a three-dimensional surface, such as a cut or broken stone surface, rough sawn wood surface, and comprise any material that can be layered or adhered to the structural layer and shaped or molded into the desired custom textured surface. The exterior texture may, for example, comprise a decorative wall coating or veneer materials used in conventional construction, such as aggregate-binder-water materials (e.g., stucco, plaster, mortar, etc.) materials, adhered fired clay materials (e.g., terracotta, brick shapes, etc.), and the like.

The exterior texture may be integrated with the substrate through an adhesive. Also, the substrate may have a rough surface or a texture that allows the exterior texture to bind more easily. There may be a mechanical interaction between the surfaces that hold them together.

An exemplary texture includes one or more of acrylic, aggregate, adhesive, and color. Exemplary materials include one or more of elastomeric acrylic finish, rubber stucco, stucco, calcium marble aggregate, acrylic resin, acrylic polymer, sand, silica sand, fiberglass mesh, lime, water, fibers, synthetic acrylics, and cement plaster. The materials used may add strength and flexibility. Also, materials used may make the texture to be breathable, water-resistant, weather-resistant, and/or fire-resistant.

The aggregate is compatible with the acrylic. The aggregate is configured to adhere to the substrate. For example, the particle size of the aggregate may have a size limitation so that it properly adheres to the substrate. The particles may also include one or more geometric shapes, such as square or rectangular blocks, marble shapes, ovoid shapes, and other shapes that enable them to adhere to the substrate. An exemplary material is a Stuc-O-Flex® finish. The makeup of the aggregate may vary and such variations known in the art are fully contemplated.

The exterior texture may contain, or be used in conjunction with, an adhesive, such as a polymer-reinforced adhesive, an acrylic polymer silicon-based glue, or other adhesive. An exemplary adhesive that is used separately may be spread over the substrate, applied using a spray, or applied using other techniques known in the art.

The structural layer may be smooth or it may have a texture to make the texture layer have better adherence. An outer facing surface of the structural layer may be, for example, rough or uneven to have texture. Moreover, any of the layers may have texture to provide better adherence or achieve other beneficial effects.

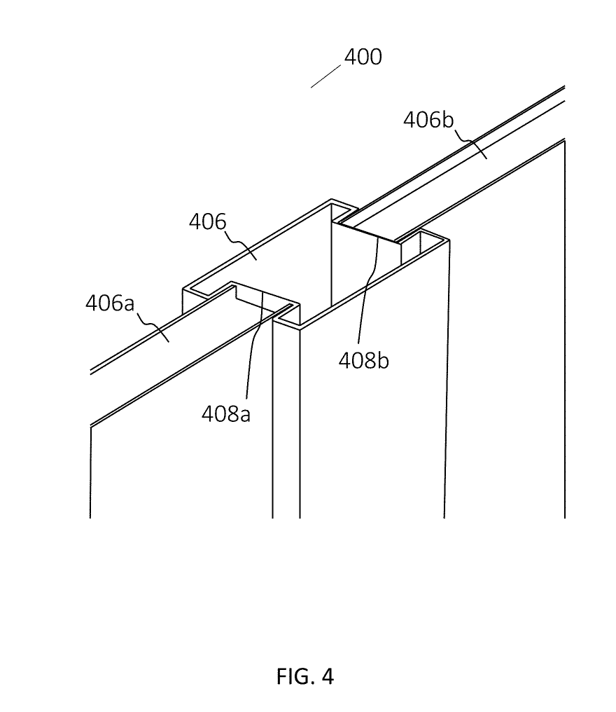

Turning to FIG. 4, the attachment of the modular panels is illustrated. Exemplary modular panels 406a and 406b are attached together via a connection to post 407. The post 407 is an elongated structure having a height that is generally equal in height of the panels, although it may have a greater or lesser height. The post 407 includes notches 408a and 408b in which respective side edges of panels 406a and 406b are slidably engaged for a tight friction fit or other type of fit. Embodiments further include that modular panels be attached together without a post.

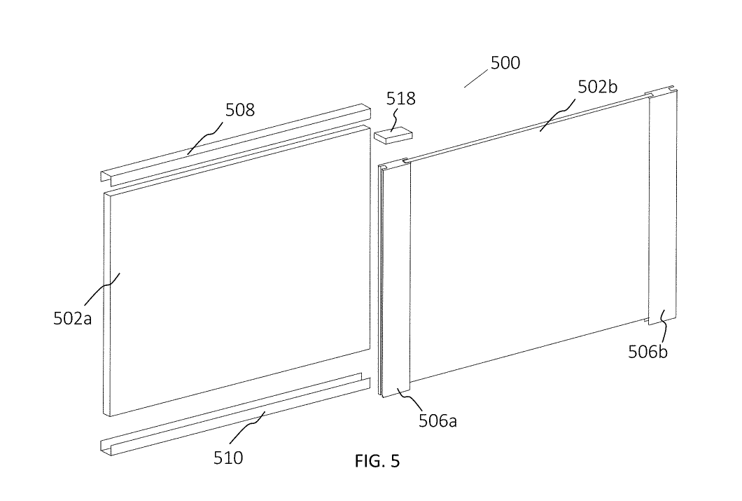

Turning to FIG. 5, a wall panel 500 is shown that includes an attached modular panel 506b next to an extruded modular panel 506a. The panel 506b is attached to posts 507a and 507b. The vertical heights of the panel and post are shown being generally the same, however, variation in height is possible, with the panel being higher or the post being higher.

Top border treatment 508 and bottom border treatment 510 are also shown. The treatments are elongated members that each include a base and two sides that converge with the base, the two sides being parallel to each other and perpendicular to respective sides of the base. The treatments effectively form a cavity in which ends of the modular panel can be inserted with a friction fit. The treatments cap off the ends of the panel and offer protection on top and bottom sides of the panel.

Alternative types of treatments may also be used to protect the modular panels. And in some instances, panels may be used without a treatment. Instead of panels, a frame having two or more sides may be attached to a panel. For example, a four-sided frame may be used to surround the panel, thereby negating the need for separate and distinct border treatments. A coating may be used to protect ends of the panels.

In one embodiment, a coating may be used to protect ends of the panels, the panels, or any component thereof (e.t., treatment, headpiece, etc). Non-limiting examples of a coating include a layer of material, varnish, laquer, film, polymer, epoxy, polyurethane, metallic, composite, fabric, non-woven sheet of polymeric fibers (e.g. polyolefin fibers, etc) and/or non-metal fibers. Properties of the coating may further provide one or more of weather barrier, corrosion-resistant, water resistance, air penetration resistance, strength resistance, tear resistance, and insulative properties. Moreover, the coating may be any conventional barrier that is used in building, construction, and renovation. According to certain embodiments, the coating may include well known and industry materials.

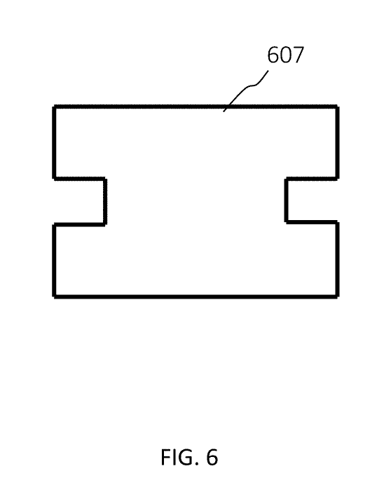

Posts 507a and 507b can attach to panels in a variety of ways. For example, an attachment in FIG. 5 includes elongated notches that extend along sides of the post and that allow side edges of the panels to be slidably engaged with a friction fit. The notches are on opposite sides of the post and are configured to accommodate a panel. The posts 507a and 507b have four sides at right angles and a rectangular cross-section. See FIG. 6 for a cross-section of a post 607 with a rectangular cross-section is shown. A variety of posts may be used, including ones that have cross-sections of a square, triangle, or polygon.

Further attachment means (e.g., screws, bolts, adhesive, etc.) may be used to secure the posts to the panels, and panels to the posts. Panels may further be attached using connection structures, such as cam lock connections, snap connections, and other types of connections.

A top headpiece 518 is shown and includes a lid with perpendicular sides that converge with the lid. The lid and sides form a box shape that fits over the top of the post and a portion of the top of the panel edges that are engaged with the post. The shape of the headpiece 518 may vary to correspond with the form of the post. Attachment means described above may be used to further secure the headpiece to the post and/or portions of the modular panels. A top headpiece may not be used in some embodiments. When using a headpiece, the type of headpiece may vary with shapes including one or more of cube, polygon, sphere, ovoid, diamond, and many other shapes that are intended to be aesthetically pleasing or have other purpose.

A method of making a modular wall panel may include one or more of the steps described herein. One or more steps may be omitted and one or more steps may be taken out of order than the order in which they are presented.

An exemplary method of making a modular wall panel includes applying a front structural layer on a front side of a core panel and a back structural layer on a back side of a core panel. Another step includes applying a front custom exterior texture attached to a front structural layer and a back custom exterior texture attached to a back structural layer. One or more border treatments may be attached to the panel. For example, a border treatment may be attached at a top edge of the panel and a border treatment may be attached to a bottom edge of the panel.

Another step includes attaching the panels together. This may include attaching sides of panels to a post.

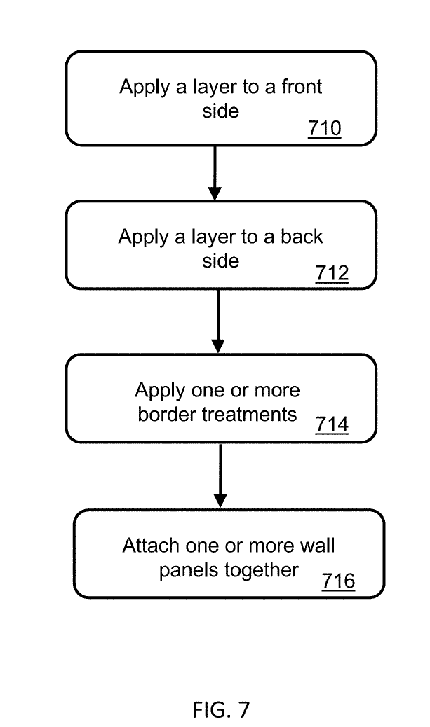

FIG. 7 is a flowchart that describes steps that may be used to form a wall using modular panels. Step 710 includes applying a layer to a front side. The front side may be the front side of a core layer. This step may be repeated to add a structure layer. This step may also be repeated to add an exterior texture. The method may incorporate a panel that already has one or more layers attached. For example, the core layer and the structural layers may come pre-attached in Dibond® panels or other manufactured assembly panels. For a core layer that already has structural layers applied, the layer in this step would be an exterior texture.

Step 712 would include applying a layer to a back side. Here again, this step is repeated for the application of a structure layer and the application of a texture layer, or exterior texture. When using a Dibond® panel or other manufactured assembly panels, this step would simply incorporate an exterior texture being applied. Note that additional types of layers are applicable to this flowchart in more layers are desired. For example, two different exterior textures could be applied to achieve a thicker texture, a unique effect, or other effect.

In step 714, the method includes applying one or more border treatments, such as the border treatments described above.

In step 716, the method includes attaching one or more wall panels together to form a wall, also described above.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

1. A modular panel for a wall system comprising:
a core substrate;
two structural layers, including a front structural layer attached to a front surface of the substrate and a back structural layer attached to a back surface of the substrate;
two exterior textures, including a front texture layer attached to the front structural layer and a back exterior texture attached to the back structural layer, the substrate, structural layers, and exterior textures forming a panel configured to be used to make one or more walls.

2. The modular panel claim 1, wherein the substrate comprises polyethylene.

3. The modular panel of claim 1, wherein the structural layers comprise aluminum.

4. The modular panel of claim 1, wherein the exterior textures comprise stucco.

5. The modular panel of claim 1, further comprising an outer protective finish coating on one or more of the substrate, structural layers, and exterior textures.

6. The modular panel of claim 4, wherein the structural layer includes a texture that is configured to make the stucco adhere to the structural layer.

7. The modular panel of claim 1, further comprising one or more elongated border treatments that attach to one or more of a top edge, bottom edge, or side edge of the panel.

8. The modular panel of claim 1, further comprising a frame attached to edges around the panel.

9. The modular panel of claim 1, further comprising posts on either side of the panel, wherein the posts have a cross-section that is any one of a square, rectangle, triangle, or polygon.

10. The modular panel of claim 9, wherein each post includes an elongated slot on one or more sides that is sized and configured to accommodate a panel.

11. The modular panel of claim 9, where each post includes an elongated slot located on opposite sides of each other, each slot being sized and configured to accommodate a panel on opposite sides of the post.

12. The modular panel of claim 1, further comprising one or more structures configured to join sides of two panels together.

13. The modular panel of claim 1, further comprising one or more cam lock connections to attach each panel together.

14. The modular panel of claim 1, further comprising one or more snap connections to attach each panel together.

15. A method of making a modular wall panel, the method comprising: applying a texture layer on both sides of a base panel, the base panel comprising a core substrate and two inner layers attached to front and back surfaces of the substrate.

16. The method of claim 15, further comprising imparting a texture to outer facing surfaces of the base panel prior to applying texture layer.

17. The method of claim 15, further comprising applying an outer protective finish coating on the stucco.

18. The method of claim 15, further comprising applying one or more elongated border treatments to one or more of an upper edge, lower edge, or side edge of the base panel.

19. The method of claim 15, further comprising attaching a frame around outer edges of the base panel.

20. The method of claim 15, further comprising attaching wall panel with another wall panel by a connection structure.
